(19) United States
(12) Patent Application Publication
(10) Pub. No.: US 2023/0286879 A1
(43) Pub. Date: Sep. 14, 2023

(54) COMPOSTING DEVICE

(71) Applicant: ALFRED KÄRCHER SE & CO. KG, Winnenden (DE)

(72) Inventors: Thomas HOFER, Winnenden (DE); Alexander BRÄNDLE, Winnenden (DE); Johannes LUSCHITZ, Winnenden (DE)

(21) Appl. No.: 18/177,859

(22) Filed: Mar. 3, 2023

Related U.S. Application Data
(63) Continuation of application No. PCT/EP2021/072361, filed on Aug. 11, 2021.

(30) Foreign Application Priority Data
Sep. 5, 2020 (DE) 10 2020 123 246.2

(51) Int. Cl. C05F 17/971; C05F 17/957; C05F 17/993

(52) U.S. Cl. CPC C05F 17/971; C05F 17/957; C05F 17/993

(57) ABSTRACT

The invention relates to a composting apparatus for providing compost material from organic material, comprising at least one initial chamber and at least one subsequent chamber, wherein the at least one initial chamber and the at least one subsequent chamber comprise a composting chamber in which organic material is convertible to compost material, wherein the at least one initial chamber comprises an introduction opening and a discharge opening and organic material is introducible into the at least one initial chamber through the introduction opening, wherein the at least one subsequent chamber comprises an introduction opening, a conveying unit on at least one initial chamber, having at least one conveying element for the organic material, said conveying element being arranged in said initial chamber; and a control device for actuating the conveying unit, wherein the organic material is conveyable by means of the conveying unit through the discharge opening for transfer to the at least one subsequent chamber.

### CROSS-REFERENCE TO RELATED APPLICATIONS

This application is a continuation application international application number PCT/EP2021/072361, filed on Aug. 11, 2021, and claims the benefit of German application number 10 2020 123 246.2, filed on Sep. 5, 2020, which are incorporated herein by reference in their entirety and for all purposes.

### FIELD OF THE INVENTION

The present invention relates to a composting apparatus for providing compost material from organic material, the apparatus comprising a composting chamber.

### BACKGROUND OF THE INVENTION

Composting apparatuses are known in which organic material to be composted is converted to compost material. The organic material to be composted is, in particular, organic wastes, for example food residues from domestic use. Accordingly, the present invention relates in particular to a composting apparatus for domestic use, by means of which, for example, kitchen waste and small plants from a private household can be converted to compost material, for example for domestic utilization. Such a composting apparatus can also be suitable for use in offices, for example.

Composting apparatuses for home use are known in the prior art. For example, US 2008/0209967 A1 describes a composting apparatus having a composting chamber. The composting chamber is arranged in a housing. A mixing unit serves for circulating the organic material. The composting chamber can be heated. After the composting process has terminated, the bottom of the composting chamber is opened. The compost material can fall into a receiving container and be removed from the housing there. Water can flow off via a bottom of the composting chamber and be collected in a separate vessel. The composting apparatus can comprise a lock into which material to be composted is introduced and temporarily stored there before it can be introduced via a flap into the composting chamber. It proves to be disadvantageous that organic material can clump in the composting chamber. When the base is opened, the problem may arise that compost material remains in the composting chamber. By opening the base, compost material can block the passage opening to the receiving container and cause a malfunction of the composting apparatus.

EP 3 275 808 B1 describes a composting apparatus having a composting chamber. The composting chamber is heated at a lower portion and cooled at an upper portion by means of an air flow. In this way, condensate is intended to be formed on an inner wall of the composting chamber, by means of which condensate the inner wall can be cleaned.

Further composting apparatuses are described, for example, in the documents DE 197 49 751 A1, US 2016/0207845 A1, US 2017/0260111 A1, EP 3 007 836 B1 and FR 2792330 A1.

A composting apparatus for industrial applications is described in KR 10-1183135 B1. Said composting apparatus comprises a drum-shaped composting chamber which can be heated. The organic material can be circulated by means of a mixing unit. Compost material can be removed by means of a closable flap after the composting process has terminated.

An object underlying the present invention is to provide a composting apparatus for providing compost material which composting apparatus has a more reliable mode of operation.

### SUMMARY OF THE INVENTION

In an aspect of the invention, a composting apparatus for providing compost material from organic material comprises:
at least one initial chamber and at least one subsequent chamber, wherein the at least one initial chamber and the at least one subsequent chamber comprise a composting chamber in which organic material can be converted to compost material, wherein the at least one initial chamber comprises an introduction opening and a discharge opening and organic material can be introduced into the at least one initial chamber through the introduction opening, wherein the at least one subsequent chamber comprises an introduction opening;
a conveying unit on at least one initial chamber, having at least one conveying element for the organic material, said conveying element being arranged in said initial chamber; and
a control device for actuating the conveying unit, wherein the organic material can be conveyed by means of the conveying unit through the discharge opening for transfer to the at least one subsequent chamber.

### BRIEF DESCRIPTION OF THE DRAWINGS

The foregoing summary and the following description may be better understood in conjunction with the drawing figures, of which:

FIG. 1: is a schematic view of a preferred embodiment of the composting apparatus in accordance with the invention;

FIG. 2: is a perspective view of the composting apparatus from FIG. 1, housing parts being removed;

FIG. 3: is a partial cross-sectional view of the composting apparatus, along the line 3-3 in FIG. 2;

FIG. 4: is a partial perspective view of a drying chamber of the composting apparatus and further components, partially cut;

FIG. 4A: is a schematic view of an end wall of the drying chamber having a discharge opening formed therein;

FIG. 5: is a partial perspective view of a conveying unit of the composting apparatus in the drying chamber;

FIG. 6: is a partial perspective view of a composting chamber of the composting apparatus and further components, partially cut; and

FIG. 7: is a partial perspective view of a conveying unit of the composting apparatus in the composting chamber.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a composting apparatus is provided for providing compost material from organic material, comprising:
at least one initial chamber and at least one subsequent chamber, wherein the at least one initial chamber and the at least one subsequent chamber comprise a composting chamber in which organic material can be converted to compost material, wherein the at least one initial chamber comprises an introduction opening and a discharge opening and organic material can be introduced into the at least one initial chamber through the introduction opening, wherein the at least one subsequent chamber comprises an introduction opening;
a conveying unit on at least one initial chamber, having at least one conveying element for the organic material, said conveying element being arranged in said initial chamber; and
a control device for actuating the conveying unit, wherein the organic material can be conveyed by means of the conveying unit through the discharge opening for transfer to the at least one subsequent chamber.

In the composting apparatus in accordance with the invention, organic material to be composted can be converted to compost material in the composting chamber. For this purpose, a heating device for heating, a ventilation device for ventilating, and/or a humidifying device for humidifying the organic material can preferably be provided in order to achieve the most advantageous composting result possible. Organic material, which in this case can be a starting material which is to be composted or compost material after completion of the composting process, is transported, in the composting apparatus in accordance with the invention, by at least one initial chamber and at least one subsequent chamber which comprise the composting chamber. In accordance with the invention, it is provided that a conveying unit which can be actuated by the control device is present on at least one initial chamber. This allows the organic material to be conveyed in a targeted manner via the conveying element in the initial chamber, through the discharge opening. As a result, the organic material can be transferred via the introduction opening into the subsequent chamber. By using the conveying unit, a material accumulation due to clumping of the organic material, for example, can preferably be avoided and the susceptibility of the composting apparatus to malfunction can be reduced as a result. In this way, the composting apparatus has a higher reliability in operation than conventional composting apparatuses.

In a preferred embodiment of the invention, a drying chamber can be provided as the initial chamber, and the composting chamber as the subsequent chamber. Such a composting apparatus can preferably comprise a heating device which is arranged on the drying chamber and which can be actuated by the control device, by means of which the organic material in the drying chamber can be heated for drying. The dried organic material can be supplied via the conveying unit of the composting chamber to the composting chamber. In such an embodiment, the material to be composted can be dried in the drying chamber. In this way, uncontrolled decomposition is prevented. Microorganisms in the organic material are preferably not killed and can remain in the dried material for the subsequent composting process. The dried organic material can preferably be stored in the drying chamber, thereby preventing odor formation, until it is transferred to the composting chamber by means of the conveying unit.

In a preferred embodiment of the invention, the composting chamber is provided as the initial chamber, and a removal container as the subsequent chamber. In this case, organic material supplied to the composting chamber can be converted to compost material. After completion of the composting process, the compost material can be supplied to the removal container via the conveying unit. The removal container can preferably be removed from the composting apparatus by the user.

The above explanations show that the composting apparatus can have more than one initial chamber and more than one subsequent chamber. In a preferred embodiment, the composting chamber can be the subsequent chamber with respect to the drying chamber. At the same time, the composting chamber can be the initial chamber with respect to the removal container.

The composting apparatus can comprise a respective conveying unit on the drying chamber and on the composting chamber. The conveying units can preferably be actuated independently of one another by the control device.

It may be favorable if the composting apparatus comprises a sensor device coupled to the control device, and if the conveying unit can be actuated depending on a signal from the sensor device. This makes it possible to detect a state of the composting apparatus in order to actuate the conveying unit in a targeted manner.

For example, the conveying unit can be controllable in order to ensure a predetermined residence time of the organic material in the initial chamber.

It can be provided, for example, that the conveying unit can be actuated when a state of the organic material is ensured before transfer into the subsequent chamber. For example, a degree of drying of the organic material in the drying chamber and/or a quality of the compost material in the composting chamber can be monitored by means of the sensor device and the conveying unit can be actuated depending on this.

It can be provided, for example, that the conveying unit can be actuated for the purpose of transferring a predetermined amount of organic material into the at least one subsequent chamber. For example, with regard to energy-efficient operation of the composting apparatus, it is ensured that a minimum amount of organic material is conveyed. Alternatively or in addition, it is ensured, for example, that a maximum amount of organic material is not exceeded in order to avoid overfilling the subsequent chamber.

The operation of the conveying unit can be triggered by a user, for example on an operating unit. It can be provided that an indication for the user is provided on an output unit, to the effect that the organic material is of a suitable quality for further transport into the subsequent chamber.

The at least one conveying unit can be designed in different ways. Two or more conveying units can have an identical or different design.

In order to move the organic material, the at least one conveying element is movable, and preferably movably mounted on the initial chamber.

In a preferred embodiment of the invention, the conveying unit comprises a drive device and a shaft which is rotatable about an axis of rotation via the drive device and on which the at least one conveying element is fixed. In this way, the conveying element can be driven by the drive device so as to rotate about the axis of rotation.

Favorably, the axis of rotation can be an axis of the at least one initial chamber, the shaft and the initial chamber being oriented coaxially to one another.

It can prove advantageous if the at least one conveying element comprises a holding portion and a sliding portion connected thereto.

Favorably, the holding portion is held on the shaft, and the sliding portion pushes organic material in the direction of the discharge opening. When the shaft rotates, the sliding portion rotates about the axis. As a result, organic material can be captured and pushed to the discharge opening.

The conveying element, in particular the sliding portion, is preferably oriented in parallel with an axis of the initial chamber, at least in portions.

Favorably, the sliding portion is a wiper portion which is movable along an inner wall of the at least one initial chamber. In this way, it can be ensured, for example, that organic material is reliably moved along an inner periphery of the initial chamber in the direction of the discharge opening. Preferably, buildup can be detached from the inner wall.

In a preferred embodiment of the invention, the at least one initial chamber comprises a first chamber region and a second chamber region. The conveying element can preferably be disk-shaped and can separate the first chamber region from the second chamber region. In this case, it can be provided that the discharge opening is arranged on the second chamber portion, and at least one recess and at least one sliding portion are arranged on the conveying element, by means of which sliding portion organic material can be conveyed through the recess from the first chamber region into the second chamber region. The chamber regions are separated from one another via the at least partially disk-shaped conveying element. For this purpose, the conveying element can be oriented, for example, transversely and in particular perpendicularly to the axis of rotation. When the conveying element is rotated, organic material can be captured in the first chamber region by the sliding portion, and moved through the recess into the second chamber region. The sliding portion is, for example, designed like a wing and protrudes from a disk-shaped portion of the conveying element at an angle to the plane of the disk portion.

The introduction opening of the initial chamber is advantageously formed on the first chamber region.

A wiper portion by means of which an edge of the discharge opening can be wiped off, is preferably arranged on the disk-shaped conveying element. In this way, any buildup of organic material at the edge of the discharge opening can be eliminated.

It is favorable for the conveying unit to be operable in two operating modes, said conveying unit being effective in a first operating mode as a conveying unit for transporting the organic material into the at least one subsequent chamber, and said conveying unit being effective in a second operating mode as a mixing unit for mixing the organic material in the at least one initial chamber. This allows a structurally simple design of the composting apparatus in that it is possible for a separate mixing unit at the initial chamber to be dispensed with.

Preferably, the conveying unit can be actuated by the control device to carry out the respective operating mode. During operation as a mixing unit, there is preferably the possibility of comminuting the organic material. In this way, the surface of the material can be increased for the purpose of an efficient drying process and an efficient composting process.

It is preferably provided that, in the second operating mode, organic material is movable, by means of at least one mixing element of the conveying unit, in a direction pointing away from the discharge opening. In this way, it is possible to prevent organic material from being inadvertently conveyed through the discharge opening.

It may be favorable, in particular, if at least one conveying element comprises or forms a mixing element, or vice versa. Depending on whether a conveying operation or a mixing operation is carried out, the same element of the conveying unit can be effective on the one hand as a conveying element or on the other hand as a mixing element. Preferably, the conveying element can move organic material in a direction pointing away from the discharge opening, in the mixing operation.

In a preferred embodiment, the operating modes of the conveying unit can differ from one another by a direction of rotation of the conveying unit about the axis of rotation. In a first direction of rotation, a mixing operation is carried out by means of the conveying unit. After reversal of the direction of rotation into the opposite direction of rotation, the conveying unit acts as such in order to convey organic material to the discharge opening.

It is favorable if the initial chamber is arranged at least in portions and preferably completely above the subsequent chamber, and if organic material can be transferred from the at least one initial chamber into the at least one subsequent chamber under the influence of gravity. By utilizing gravity, the transport of organic material from the initial chamber into the subsequent chamber can be facilitated.

Position and orientation information such as “above”, “below” or the like refer in the present case to a use of the composting apparatus as intended. In this case, the composting apparatus is positioned on a set-down surface, in particular via a set-down device. A contact plane of the set-down device coincides with a set-down plane of the set-down surface. The set-down surface can be regarded in a non-limiting manner as horizontally oriented.

It can be advantageous if the subsequent chamber projects beyond an outer contour of the initial chamber. In this way, a space-saving arrangement of the initial chamber and the subsequent chamber in a housing of the composting apparatus can be achieved.

It can be provided that the introduction opening of the at least one initial chamber is arranged on the upper side thereof.

Alternatively or in addition, the introduction opening of the at least one subsequent chamber can be arranged on the upper side thereof.

It may be favorable, in particular, if the composting apparatus is free of moving elements at the discharge opening, at the introduction opening and/or at a channel extending therebetween. Moving elements such as flaps, sliders, valves or the like can be avoided in view of a structurally simple design of the composting apparatus. This makes it possible to prevent such elements from being blocked by, for example, adhering organic material, and causing a malfunction of the composting apparatus.

Preferably, the at least one initial chamber comprises a wall arrangement having a bottom wall on which the organic material rests, the discharge opening preferably being arranged above the bottom wall and/or above an apex of the bottom wall. For example, in the case of a concavely formed bottom wall, the discharge opening can be arranged above a lower apex of the bottom wall, for example an apex line.

A wall portion is preferably present between the discharge opening and the bottom wall and in particular the apex, such that the free (clear) cross section of the discharge opening is at a distance from the bottom wall and in particular from the apex. As a result, liquid which exits from moist organic material can be retained on the wall portion and does not reach the subsequent chamber through the discharge opening.

Preferably, the bottom wall is free of a discharge opening. Any blockage due to organic material sinking downwards can thus be avoided. In addition, it is possible to prevent liquid which escapes from moist organic material from passing through the discharge opening into the subsequent chamber.

It can prove favorable if the at least one initial chamber comprises only one discharge opening and if the at least one subsequent chamber comprises only one introduction opening.

In a preferred embodiment of the invention, the at least one initial chamber is cylindrical or substantially cylindrical and defines an axis, the wall arrangement comprising a jacket-like side wall surrounding the axis, and opposite end walls, in particular front walls.

Favorably, the axis is oriented in parallel with a contact plane of the composting apparatus for contacting a set-down surface. The axis can in particular be oriented horizontally.

It can be advantageous if the discharge opening is formed in the side wall.

In this case, for example, at least one of the following can be provided:
the discharge opening is arranged at least in portions above the axis;
the discharge opening is designed as an overflow opening into which the organic material can be raised by means of the conveying element;
the discharge opening is slot-shaped;
the discharge opening extends in parallel with the axis.

A discharge opening in the side wall is preferably formed on the composting chamber. Preferably, compost material is raised by means of a conveying element, having a sliding portion on the inside, along the side wall, and supplied to the discharge opening.

In a preferred embodiment of the invention, it can be provided that the discharge opening is formed in an end wall. In this case, at least one of the following is optionally provided:
a wall portion of the end wall, in particular of the front wall, is present between the discharge opening and the bottom wall, in particular an apex of the bottom wall;
the discharge opening is arranged at least in portions below and/or at least in portions above the axis;
the discharge opening is arranged off-center relative to the axis. In the present case, this can be understood in particular to mean that the axis does not traverse or intersect the discharge opening.
the discharge opening is round;
the organic material can be pressed through the discharge opening by means of the conveying element.

For example, a discharge opening is provided on an end wall, and specifically a front wall, in a drying chamber. The conveying element can be disk-shaped and can transfer organic material from a first chamber region into a second chamber region during a rotation. During the rotation, the organic material is preferably pressed through the discharge opening, and, favorably, the edge is wiped off by means of a wiper portion.

It is favorable if a channel is provided into which the initial chamber opens via the discharge opening and which opens into the subsequent chamber via the introduction opening.

The channel can, for example, be in the form of a shaft and extend at least in portions in a vertical direction. Organic material can preferably fall into the subsequent chamber through the channel, under the influence of gravity.

In order to achieve a structurally simple design, a wall arrangement of the channel, for example, is moulded on a wall arrangement of the at least one initial chamber and/or the at least one subsequent chamber.

The composting apparatus favorably comprises at least one heating device on the at least one initial chamber and/or on the at least one subsequent chamber, by means of which a wall arrangement of the at least one initial chamber and/or of the at least one subsequent chamber can preferably be heated. For example, a bottom wall of the wall arrangement can be heated. Organic material in the initial chamber or the subsequent chamber can be heated as a result, for example during a drying process or during a composting process.

The composting apparatus preferably comprises at least one ventilation device having at least one pressure generation unit and at least one air guide part by means of which air can be guided to or into the at least one initial chamber and/or into the at least one subsequent chamber. For example, air can be used as drying air for the drying chamber in order to accelerate the drying process. Alternatively or in addition, air can be supplied to the composting chamber in order to promote an aerobic composting process.

The at least one heating device and the at least one ventilation device can preferably be actuated by the control device.

The at least one air guide part preferably surrounds the wall arrangement of the at least one initial chamber and/or the wall arrangement of the at least one subsequent chamber, at least in portions, the air flowing along between the air guide part and the wall arrangement, and the air being heatable by means of the at least one heating device. In particular, the heating device can be arranged on the air guide part, for example in an intermediate space between the wall arrangement and the air guide part. The preheated air can, for example, accelerate the drying process or the composting process.

The following description of a preferred embodiment of the invention serves in conjunction with the drawing to explain the invention in more detail.

The preferred embodiment explained below of the composting apparatus in accordance with the invention, which is denoted as a whole by reference numeral 10 in the drawing, serves to provide compost material 12 after decomposition of a starting material. The starting material is organic material 14 to be composted. The organic material 14 comprises, for example, kitchen waste or small plants. The composting apparatus (hereinafter apparatus) is provided in particular for home use; it can also be used, for example, in offices.

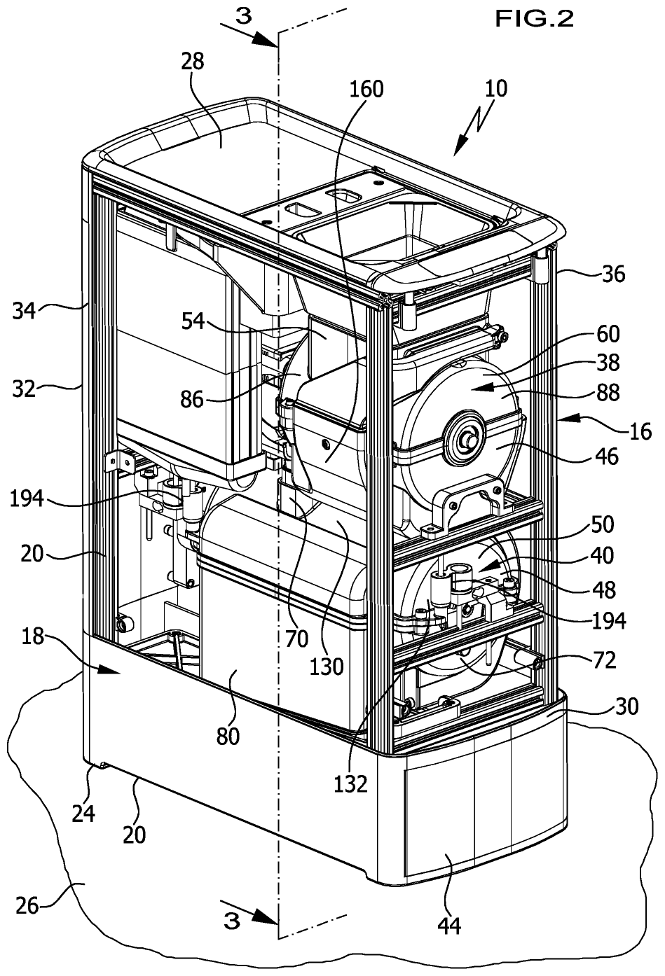

The apparatus 10 comprises a support device 16 having a housing 18, the wall arrangements of which are held on a frame 20. The wall arrangements are partially hidden in FIG. 2 in order to give a free view into the housing 18.

In the intended use, the apparatus 10 can, for example, be positioned on a set-down surface 26, for example a floor surface, by means of a set-down device 24 formed on an underside 22. A contact plane defined by the set-down device 24 coincides with the plane of the set-down surface 26. The set-down surface 26 can be considered, in a non-limiting manner, to be oriented horizontally.

Position and orientation information relates to an intended use of the apparatus 10, in which said device is positioned in particular upright on the set-down surface 26. The apparatus has an upper side 28, a front side 30, a rear side 32, a left-hand side 34, and a right-hand side 36.

In the following, firstly the basic structure of the apparatus 10 with its components is presented, which components will subsequently be described in detail.

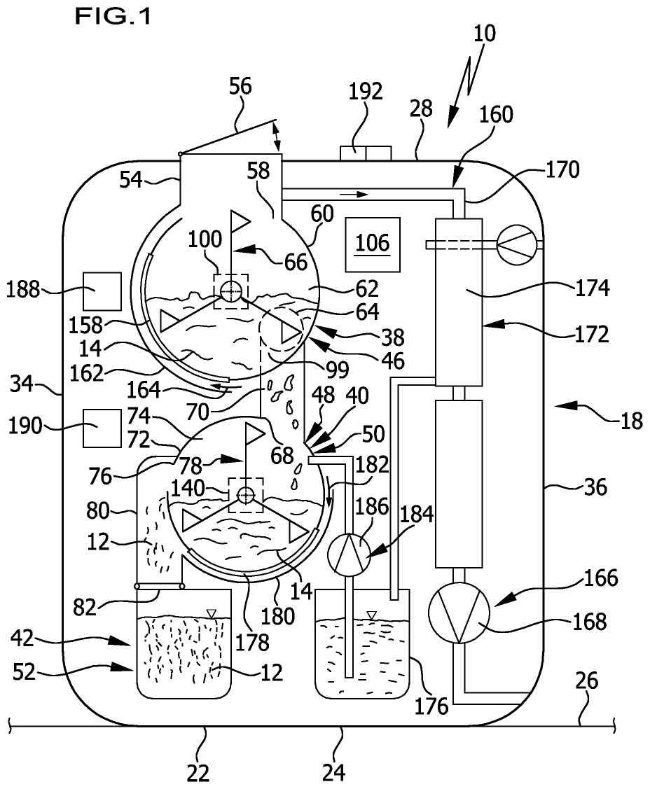

As can be seen in particular from FIGS. 1 to 3, the composting apparatus 10 comprises a first chamber, in the present case a drying chamber 38 for drying organic material 14.

Furthermore, a second chamber is provided, which in the present case is a composting chamber 40. The composting chamber 40 is used for composting dried organic material supplied from the drying chamber 38.

The drying chamber 38 is arranged above the composting chamber 40. In this case, a contour of the composting chamber 40 projects beyond the drying chamber 38, in particular in the longitudinal direction from the front side 30 to the rear side 32.

The composting apparatus 10 comprises a removal container 42. The removal container 42 is provided for receiving compost material 12 which is supplied from the composting chamber 40.

In the present example, the removal container 42 is arranged below the composting chamber 40. In this case, the removal container 42 is arranged offset from the composting chamber 40, in the transverse direction from the right-hand side 36 to the left-hand side 34, and projects beyond its outer contour in the direction of the right-hand side 36.

The removal container 42 can be removed from the housing 18 in order to supply compost material 12 for use. For this purpose, a cover element 44 on a lower portion of the front side 30 can be opened.

In the present invention, the apparatus 10 comprises at least one initial chamber and at least one subsequent chamber. In the present example, the drying chamber 38 is an initial chamber 46 with respect to the composting chamber 40. The composting chamber 40 is a subsequent chamber 48 of the drying chamber 38.

Furthermore, the composting chamber 40 is an initial chamber 50 with respect to the removal container 42. The removal container 42 is a subsequent chamber 52 with respect to the composting chamber 40.

The designations initial chamber and subsequent chamber refer to transport of organic material 14 through the apparatus 10, in its intended use. In this case, organic material 14 is dried in the drying chamber 38 and supplied to the composting chamber 40 for composting. After the composting process, transport into the removal container 42 takes place.

The organic material 14 can be introduced into a channel 54 opening at the upper side 28. The channel 54 can be sealed in an odor-tight manner by means of a cover element 56. In the present case, the channel 54 is in the form of a shaft and opens into the drying chamber 38, which comprises an introduction opening 58. The drying chamber 38 has a wall arrangement 60 and an interior 62 enclosed by said wall.

Furthermore, the drying chamber 38 comprises a discharge opening 64. Organic material 14 can be conveyed through the discharge opening 64, by means of a conveying unit 66 on the drying chamber 38, in the direction of the composting chamber 40.

In order to supply the organic material 14, the composting chamber 40 comprises an introduction opening 68. A channel 70, which is in the form of a shaft in the present case, opens into the composting chamber 40 via the introduction opening 68. The channel 70 begins at the discharge opening 64.

The composting chamber 40 comprises a wall arrangement 72 and an interior 74 enclosed thereby. Furthermore, the composting chamber 40 comprises a discharge opening 76. After the composting process, compost material 12 can be conveyed by means of a conveying unit 78 through the discharge opening 76 in the direction of the removal container 42.

A channel 80, which in the present case is designed as a shaft, opens into the removal container 42 via an introduction opening 82. The channel 80 is connected to the composting chamber 40 via the discharge opening 76.

In the present case, the channels 54, 70 and 80 are oriented at least in portions in the vertical direction of the apparatus 10 in order to facilitate the transport of the organic material 14 from top to bottom after the respective processing step.

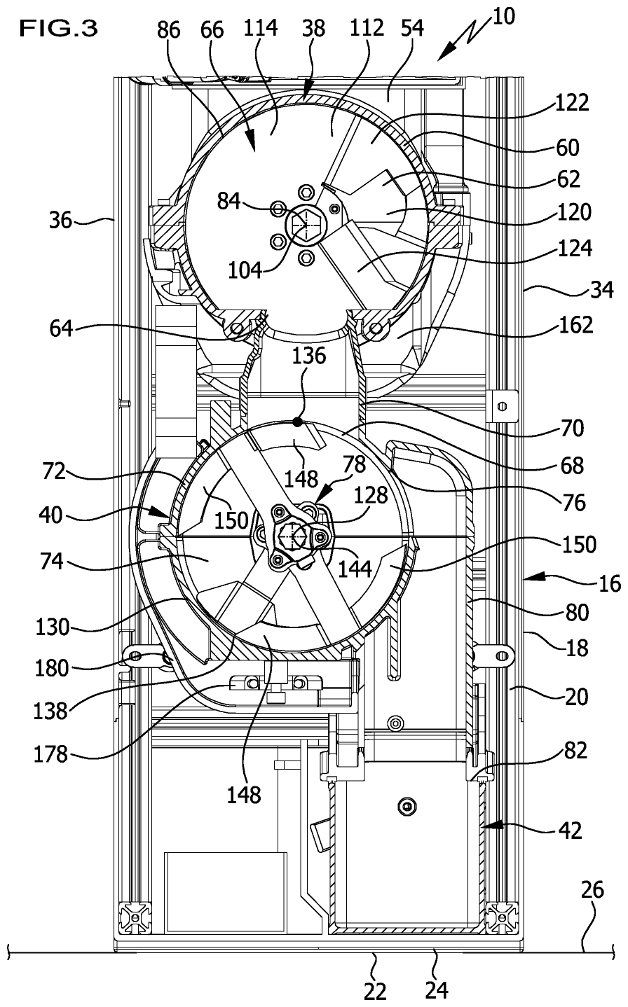

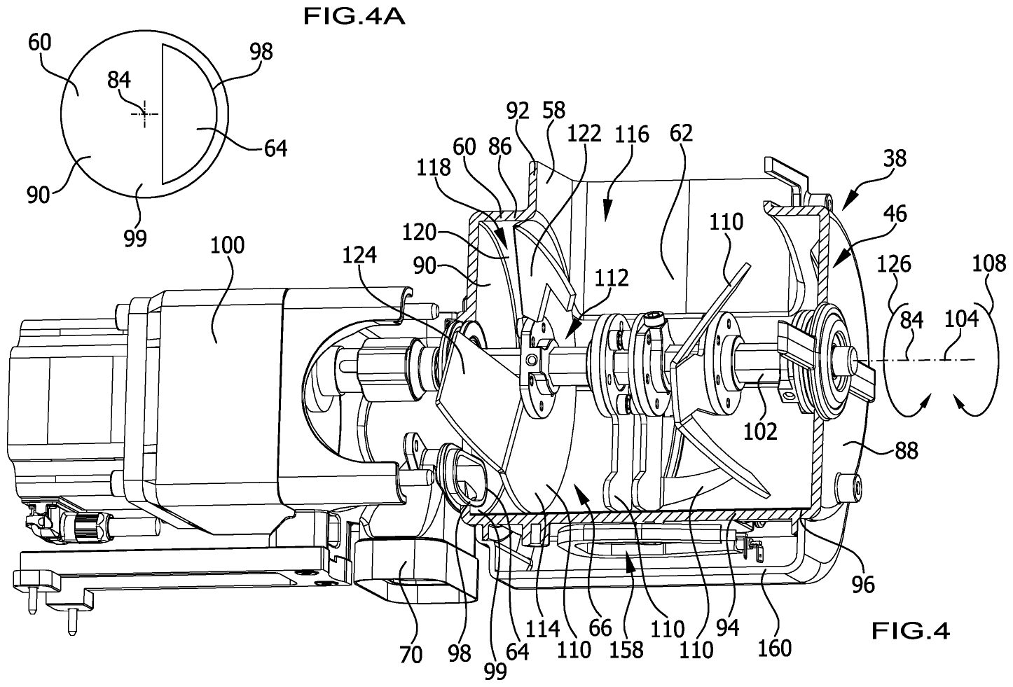

As is clear in particular from FIGS. 3 and 4, the drying chamber 38 has a substantially cylindrical shape. The drying chamber 38 is oriented “lying down” and is fixed to the frame 20. An axis 84 defined by the drying chamber 38 is preferably oriented in parallel with the contact plane, in particular horizontally.

The wall arrangement 60 comprises a peripheral jacket-like side wall 86. At the front, the wall arrangement 60 has an end wall, in particular a front wall 88. At the rear, the wall arrangement 60 has an end wall, in particular a front wall 90.

The introduction opening 58 is formed at the top of the side wall 86 and is of a sufficiently large cross section that even unshredded organic material 14 can be easily introduced into the interior 62. An edge 92 which projects upward from the side wall 86 encloses the introduction opening 58.

The side wall 86 forms a bottom wall 94 which defines an apex line 96 on the underside. The apex line 96 defines the lowest point of the bottom wall 94.

In the present example, the discharge opening 64 is formed on the rear end wall 90. In the present case, the discharge opening 64 is round and approximately elliptical or kidney-shaped.

In the present exemplary embodiment, the discharge opening 64 is arranged below the axis 84 and is substantially symmetrical in relation to a central longitudinal plane of the drying chamber 38 (FIG. 4). An edge 98 encloses the discharge opening 64.

A wall portion 99 of the front wall 90 is arranged between the free cross section of the discharge opening 64 and the bottom wall 94, in particular the apex line 96. The wall portion 99 can be formed or comprised entirely or in part by the edge 98. Liquid which escapes from moist organic material 14 can be retained on the wall portion 99 and does not reach the composting chamber 40 through the discharge opening 64.

It can prove advantageous to arrange the discharge opening 64 so as to be off-center with respect to the axis 84.

It can be advantageous if the discharge opening 64 is formed at least in part above the axis 84, in the end wall. FIG. 4A shows, by way of example, a front wall 90 having the discharge opening 64. Said opening is enlarged and positioned higher compared to the construction according to FIG. 4. The wall portion 99 is enlarged and can retain even more liquid. Due to the free cross-sectional area, larger particles of organic material 14 can also be conveyed.

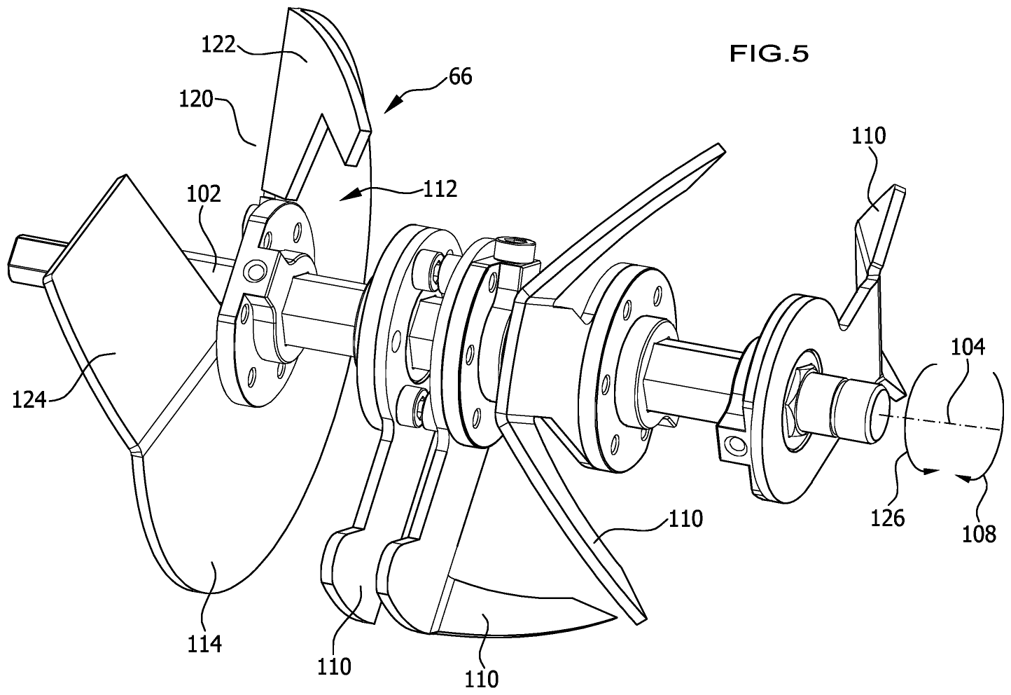

As is further apparent in particular from FIGS. 4 and 5, the conveying unit 66 comprises a drive device 100 and a shaft 102. The shaft 102 can be driven by the drive device 100 so as to rotate about an axis of rotation 104. In the present case, the axis of rotation 104 coincides with the axis 84. References to the axis of rotation 104 are therefore also references to the axis 84, and vice versa.

A control device 106 of the apparatus 10 is provided. The control device 106 is used for controlling and/or regulating the components of the apparatus 10.

In particular, the drive device 100 can be actuated by the control device 106. It is possible to selectively rotate the shaft 102 in one of two mutually opposite directions of rotation. In one direction of rotation 108, the conveying unit 66 acts as a mixing unit in order to mix and shred organic material 14 in the drying chamber 38. For this purpose, the conveying unit 66 comprises at least one mixing element 110. In the present case, a plurality of mixing elements 110 are provided. The mixing elements 110 can, for example, have a hook-shaped design and/or comprise cutting edges for shredding the organic material 14.

In order to transport organic material 14 to the discharge opening 64, the conveying unit 66 further comprises a conveying element 112 which is fixed to the shaft 102.

In the present exemplary embodiment, the conveying element 112 is disk-shaped and comprises a disk portion 114. The disk portion 114 is, for example, planar and preferably oriented transversely and in particular perpendicularly to the axis of rotation 104. In this case, the disk portion 114 is dimensioned such that it is preferably arranged in a form-fitting manner in the interior 62 (FIGS. 3 and 4).

In this way, the disk portion 114 separates a first chamber region 116 from a second chamber region 118 of the drying chamber 38.

Preferably, the disk portion 114 is arranged substantially below the edge 92. In this way, introduced organic material 14 enters the first chamber region 116 in front of the disk portion 114. The first chamber region 116 extends as far as the front wall 88. The second chamber region 118 extends from the disk portion 114 to the rear front wall 90.

On the conveying element 112, a recess 120 is formed through which organic material 14 can pass from the first chamber region 116 into the second chamber region 118. For this purpose, the conveying element 112 further comprises a sliding portion 122 for pushing organic material 14. The sliding portion 122 is oriented at an angle to the plane of the disk portion 114 and to the axis of rotation 104 (FIGS. 4 and 5). The sliding portion 122 projects into the first chamber region 116 and is arranged at the edge of the recess 120.

At an opposite edge of the recess 120, the conveying element 112 further comprises a wiper portion 124. The wiper portion 124 is oriented at an angle to the plane of the disk portion 114 and to the axis of rotation 104. In this case, the wiper portion 124 projects into the second chamber region 118. The wiper portion 124 is dimensioned such that its free end projects up to the front wall 90 and can wipe over the edge 98 of the discharge opening 64.

In order to function as a conveying unit 66, the shaft 102 can be rotated about a direction of rotation 126 which is opposite to the direction of rotation 108. In this case, the actuation is carried out by the control device 106. In this way, the conveying unit 66 can assume two different operating modes. In a first operating mode, it acts as a conveying unit, the shaft 102 rotating in the direction of rotation 126. In the case of reversal of the direction of rotation, the conveying unit 66 acts as a mixing unit, and the shaft 102 rotates in the direction of rotation 108.

During operation of the apparatus 10, the conveying unit 66 initially acts as a mixing unit in order to shred and loosen organic material 14. In this way, the drying process for the organic material 14, which is assisted by the heating device mentioned below, is promoted. The disk portion 114 largely prevents material 14 from reaching the vicinity of the discharge opening 64.

If the organic material 14 is to be transferred into the composting chamber 40, the direction of rotation of the conveying unit 66 can be reversed. The shaft 102 is rotated in the direction of rotation 126.

In this case, the organic material 14 is captured by means of the sliding portion 122. The organic material 14 is conveyed through the recess 120, from the first chamber region 116 into the second chamber region 118. As a result, the organic material 14 reaches the discharge opening 64 arranged on the second chamber region 118. A preferably predefined quantity or portion of dried organic material 14 is pressed into the discharge opening 64. Any residues of organic material 14 adhering to the wall arrangement 60 can be wiped off by means of the wiper portion 124.

If no material 14 is conveyed, the discharge opening 64 can remain free. Sealing is not necessary, which considerably reduces the susceptibility of the apparatus 10 to malfunction. In conventional composting apparatuses, sealing surfaces in particular can be covered by solid organic material. Secure closing of such an opening can be ensured.

The conveying element 112 forms a mixing element 110. In mixing operation, organic material 14 can be moved from the second chamber region 118 into the first chamber region 116, away from the discharge opening 64. When organic material 14 enters the vicinity of the discharge opening 64, in the present example it is captured by the wiper portion 124 and moved through the recess 120 into the first chamber region 116. The wiper portion accordingly forms a sliding portion. In mixing operation, material 14 on the disk portion 114 can be captured by the sliding portion 122 and moved further into the first chamber region 116.

It is advantageous that organic material 14 can be supplied in a targeted manner to the discharge opening 64 by means of the conveying unit 66. Any blockages caused by adhering organic material 14 in the drying chamber 38 can be avoided. Preferably, this also applies to the first chamber region 116, in which the mixing elements 110 can serve as wiper elements for the inside of the wall arrangement 60.

It is favorable that the bottom wall 94 is free of a discharge opening. Any blockage caused by organic material 14 sinking downwards can be avoided.

Instead, the organic material 14 is transported by means of the conveying unit 66 in a targeted manner via the discharge opening 64 and the channel 70 into the composting chamber 40.

It is favorable that the channel 70, the discharge opening 64 and the introduction opening 68 are free of movable elements such as flaps. This firstly ensures reliable operation of the apparatus 10. Secondly, a simple structural design is achieved.

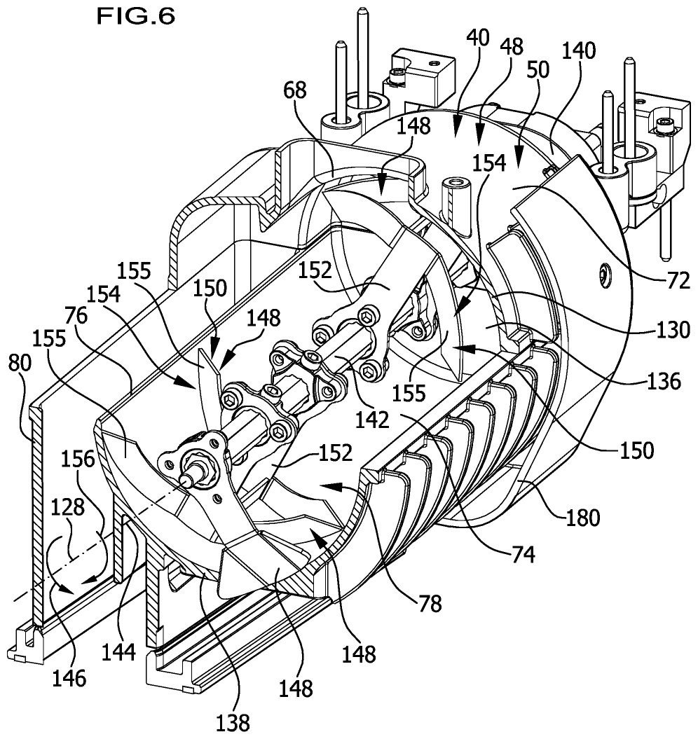

As can be seen in particular from FIGS. 3 and 6, the composting chamber 40 has a substantially cylindrical shape. The composting chamber 40 is oriented “lying down” and is fixed to the frame 20. An axis 128 defined by the composting chamber 40 is preferably oriented in parallel with the contact plane, in particular horizontally.

The wall arrangement 72 comprises a peripheral jacket-like side wall 130. At the front, the wall arrangement 72 has an end wall, in particular a front wall 132. At the rear, the wall arrangement 72 has an end wall, in particular a front wall 134.

The introduction opening 68 is formed at the top of the side wall 132. In this case, the introduction opening 68 is arranged in the region of an upper apex line 136. It is advantageous that the composting chamber 40 projects beyond the drying chamber 38. In this way, the organic material 14 falling through the channel 70 passes directly, without deflections, into the interior 74.

The side wall 132 forms a bottom wall 138.

In the present example, the introduction opening 76 is formed on the side wall 130. In the present case, the discharge opening 76 is slot-shaped or window-shaped. The discharge opening 76 is preferably arranged at least in portions above the axis 128 and/or is oriented in parallel therewith. In the present case, the discharge opening 76 is arranged as a whole above the axis 128 (FIG. 3). In this way, the composting chamber 40 can be filled with a large amount of dried organic material 14 for the composting process without said organic material unintentionally entering the channel 80.

In the present case, the discharge opening 76 is an overflow opening through which compost material 12 can be conveyed into the channel 80 after the composting process.

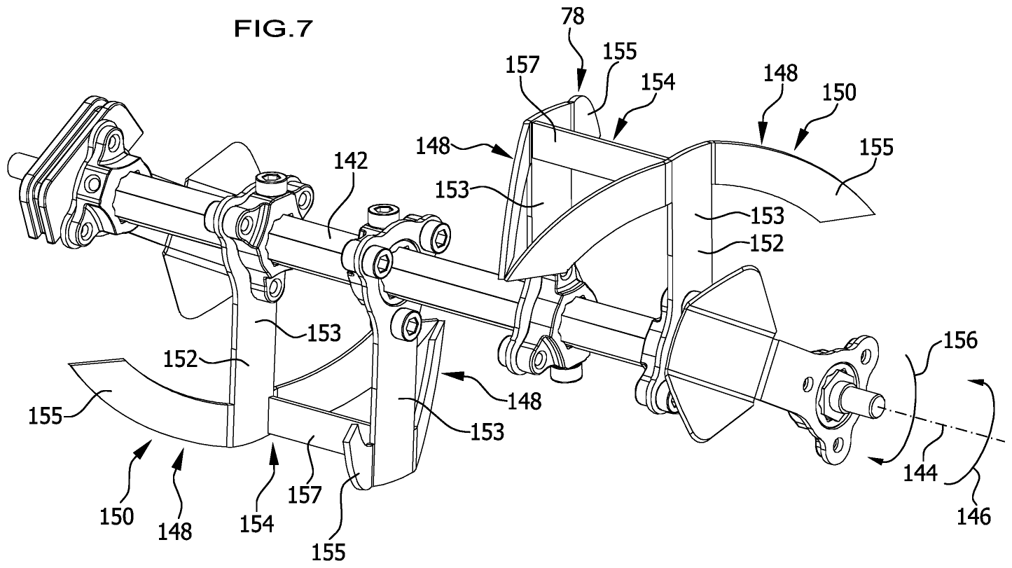

As is further apparent in particular from FIGS. 6 and 7, the conveying unit 78 comprises a drive device 140 and a shaft 142. The shaft 142 can be driven by the drive device 140 so as to rotate about an axis of rotation 144, and is mounted on the wall arrangement 72. The axis of rotation 144 coincides with the axis 128. References to the axis of rotation 144 are therefore also references to the axis 128, and vice versa.

In particular, the drive device 140 can be actuated by the control device 106. It is possible to selectively rotate the shaft 142 in one of two mutually opposite directions of rotation. In one direction of rotation 146, the conveying unit 78 acts as a mixing unit in order to mix organic material 14 in the composting chamber 40. In this case, the organic material 14 can be shredded.

For this purpose, the conveying unit 78 comprises at least one mixing element 148. In the present case, a plurality of mixing elements 148 are provided. In the present exemplary embodiment, the mixing elements 148 are wedge-shaped or plow-shaped. In this case, the mixing elements 148 each comprise two segments oriented at an angle to the axis 128, relative to a projection onto the side wall 130. The mixing elements 148 could be configured differently.

When the organic material 14 is mixed, the shaft 142 rotates in the direction of rotation 146. In this way, the organic material 14 is moved away from the discharge opening 76. In the present example, the material 14 is displaced by the segments of the mixing elements 148 having a directional component obliquely to the axis 128, such that axial mixing is also carried out.

The mixing elements 148 contact the wall arrangement 72 on the inside. Any adhering organic material 14 is detached from the wall arrangement 72 in this way.

In mixing operation, the rotational speed of the shaft 142 is preferably set such that organic material 14 is raised by means of the mixing elements 148, but preferably at most up to approximately the apex line 136, so that material 14 is not thrown through the discharge opening 76. Already below the apex line, or from there, the organic material 14 falls back in the direction of the bottom wall 138.

For transport of composted organic material 14 to the discharge opening 76, the conveying unit 78 further comprises at least one conveying element 150. In the present exemplary embodiment, two conveyor elements 150 are provided which are fixed to the shaft 142.

Each conveying element 150 comprises one holding portion 152, respectively, for fixing to the shaft 142. In the present case, the respective holding portion 152 has two segments 153 arranged at a distance from one another. The segments 153 are, for example, oriented radially with respect to the axis of rotation 144. The holding portion 152 could also be configured differently.

Furthermore, the conveying element 150 comprises a sliding portion 154. The sliding portion 154 connects the segments 153 to one another via a segment 157, and furthermore comprises a further segment 155 protruding from each segment 153. The segments 155 are oriented in directions pointing away from one another and in the present case oriented at an angle to the axis 128, relative to a projection onto the side wall 130. In this way, the sliding portion 154 widens in the direction pointing from the holding portion 152.

The sliding portion 154 is oriented in portions, in the present case on the segment 157, in parallel with the axis 128.

Overall, the sliding portion 154 is approximately trough-shaped in plan view (\_/).

In the present case, the holding portion 152 is also a holding portion for the mixing element 148 on which, for example, the aforementioned wedge or plow of the mixing element 148 is arranged (FIG. 7).

In relation to a projection onto the side wall 130, the conveying element 150 and the mixing element are substantially in the shape of an inverted A (\_/ and \/ combined).

The conveying element 150 is dimensioned such that the sliding portion 154 can wipe along the inside of the side wall 130. The sliding portion 154 acts in this way as a wiper element for the side wall 130.

The two conveying elements 150 are dimensioned and positioned such that the side wall 130 can be wiped off along substantially the entire extension of the discharge opening 76, on the inside. In this way, no dead spaces arise during conveying of the compost material 12.

In the present example, the conveying elements 150 are fixed on the shaft 142 such that they have an angular distance of substantially 180° relative to the axis of rotation 144.

In order to function as a conveying unit 78, the shaft 142 can be rotated about a direction of rotation 156 which is opposite to the direction of rotation 146. In this case, the actuation is carried out by the control device 106. In this way, the conveying unit 78 can assume two different operating modes. In a first operating mode, it acts as a conveying unit 78, the shaft 142 rotating in the direction of rotation 156. In the case of reversal of the direction of rotation, the conveying unit 78 acts as a mixing unit, and the shaft 142 rotates in the direction of rotation 146.

During operation of the apparatus 10, the conveying unit 78 initially acts as a mixing unit in order to further shred and loosen the supplied organic material 14. In this way, the composting process for the production of the compost material 12 is promoted.

If the compost material 12 is to be transferred into the removal container 42 after completion of the composting process, the direction of rotation of the conveying unit 78 can be reversed. The shaft 142 is rotated in the direction of rotation 156.

As a result, the compost material 12 is captured by means of the sliding portion 154. The compost material 12 is raised and conveyed along the inner periphery of the side wall 130 to the discharge opening 76 and through it into the channel 80. The compost material 12 falls through the channel 80 into the removal container 42.

The conveying element 150 forms a mixing element 148. In mixing operation, organic material 14 can be moved away from the discharge opening 76.

It is advantageous that compost material 12 can be supplied in a targeted manner to the discharge opening 76 by means of the conveying unit 78. As mentioned, material adhering to the wall arrangement 72 can be detached by means of the sliding portions 154.

It is favorable that the bottom wall 138 is free of a discharge opening. Any blockage caused by compost material 12 sinking downwards can be avoided.

Instead, the compost material 12 is conveyed by means of the conveying unit 78 in a targeted manner via the discharge opening 76 and the channel 80 into the removal container 42.

It is favorable that the channel 80, the discharge opening 76 and the introduction opening 82 are free of movable elements such as flaps. On the one hand, this ensures reliable operation of the apparatus 10. On the other hand, a simple structural design is achieved.

A compact design can be achieved in the case of the apparatus 10 in that the removal container 42 projects beyond the outer contour of the composting chamber 40 in the lateral direction. The removal container 42 is oriented in parallel with the composting chamber 40 in the longitudinal direction. The overall height of the apparatus 10 can thereby be kept low.

As can be seen in particular from FIG. 1, the apparatus 10 comprises a heating device 158 arranged on the drying chamber 38. The heating device 158 comprises a heating element which is arranged on the bottom wall 94 and heats the latter. In this way, the organic material 14 in the interior 62 can be heated and thus dried. This makes it possible to avoid undesired compost formation in the drying chamber 38. Odor formation is prevented. The dried organic material 14 can also be stored in the drying chamber 38 for a longer period of time.

The apparatus 10 comprises a ventilation device 160 having an air guide part 162 arranged on the drying chamber 38. The air guide part 162 surrounds the wall arrangement 60, in particular the side wall 86, at least in portions. Air from the housing 18 can be sucked into an intermediate space between the air guide part 162 and the wall arrangement 60 (arrow 164). For this purpose, the ventilation device 160 comprises a pressure generation unit 166 which generates negative pressure.

The pressure generation unit 166 is in the present case a fan 168 which is in flow connection with the drying chamber 38 via a channel 170. Drying air can be sucked through the air guide part 162 to the introduction opening 58 and penetrate into the drying chamber 48. The drying air can absorb moisture and is sucked in via the channel 170 and discharged into the atmosphere.

A condensation device 172 having a condenser 174 and a condensate container 176 is provided in order to dehumidify the drying air and absorb condensate.

In the present example, the heating element of the heating device 158 is arranged in the intermediate space between the wall arrangement 60 and the air guide part 162 (FIG. 4). This makes it possible to heat the drying air using the heating device 158 and, in this way, to increase the removal of steam from the drying chamber 38 and to accelerate the drying process.

Furthermore, the apparatus 10 comprises a heating device 178 which is arranged on the composting chamber 40. The wall arrangement 72, in particular the bottom wall 138, can be heated using the heating device 178. During the composting process, the organic material 14 can be heated as a result.

The ventilation device 160 comprises a further air guide part 180. The air guide part 180 surrounds the wall arrangement 72, in particular the side wall 130, at least in portions. Air can be sucked out of the housing 18 through the air guide part 180 (arrow 182).

The air can be heated by means of a heating element of the heating device 178. For this purpose, the heating element is arranged in the intermediate space between the wall arrangement 72 and the air guide part 180 (FIG. 3).

The air guide part 180 opens into the channel 80. The air passes through the channel 80 and the composting chamber 40 to reach the drying chamber 38 via the channel 70, and is suctioned out therefrom via the channel 170.

The air in the composting chamber 40 allows an aerobic composting process to be carried out, which is assisted by the additional heating by means of the heating device 178.

Furthermore, the apparatus 10 comprises a humidifying device 184. Via the humidifying device 184, liquid can be conveyed, in particular from the condensate container 176, into the composting chamber 40 by means of a pump 186. The re-humidification of the organic material 14 in the composting chamber 40 achieves a better composting result. Moisture can be removed by means of the air.

The heating devices 158 and 178 can be actuated by means of the control device 106, as can the condensation device 172 and the humidification device 184.

The apparatus 10 comprises sensor devices 188 and 190 on the drying chamber 38 and the composting chamber 40, respectively. The sensor devices 188, 190 are coupled to the control device 106. In particular, it is possible to control and/or regulate the operation of the apparatus 10 depending on signals from the sensor devices 188, 190.

In the present example, it is provided in particular to control and/or regulate the conveying units 66 and 78.

For example, the state of the organic material 14 in the drying chamber 38 can be monitored. If the control device 106 determines that the organic material 14 is sufficiently dried and could be composted, an indication in this regard can be output to a user at an operating unit 192. The user can trigger the actuation of the conveying unit 66. Alternatively, the conveying unit 66 is automatically actuated by the control device 106.

By reversing the direction of rotation, dried organic material 14 is transferred, as explained above, into the composting chamber 40 using the conveying unit 66.

By means of a signal from the sensor device 190, it is possible to check, for example, that the amount of organic material 14 supplied does not exceed a maximum amount in order to prevent overfilling of the composting chamber 40. Alternatively or in addition, it can be provided for a minimum amount of organic material 14 to be supplied, with a view to ensuring energy-efficient use of the apparatus 10.

For this purpose, the sensor device 190 comprises, for example, a weight sensor in order to determine a change in mass of the composting chamber 40. In the present case, the composting chamber 40 is fixed to the frame 20 via at least one load cell 194.

The state of the composting chamber 40 can be monitored via the sensor device 190, and it can be determined whether the compost material 12 is of a desired quality after the composting process. In this case, reversing the direction of rotation makes it possible for the conveying unit 78 to become operative in order to transfer compost material 12 into the removal container 42 as explained above.

### LIST OF REFERENCE NUMERALS

10 Composting apparatus (apparatus)
12 Compost material
14 Organic material
16 Support device
18 Housing
20 Frame
22 Underside
24 Set-down device
26 Set-down surface
28 Upper side
30 Front side
32 Rear side
34 Left-hand side
36 Right-hand side
38 Drying chamber
40 Composting chamber
42 Removal container
44 Cover element
46 Initial chamber
48 Subsequent chamber
50 Initial chamber
52 Subsequent chamber
54 Channel
56 Cover element
58 Introduction opening
60 Wall arrangement
62 Interior
64 Discharge opening
66 Conveying unit
68 Introduction opening
70 Channel
72 Wall arrangement
74 Interior
76 Discharge opening
78 Conveying unit
80 Channel
82 Introduction opening
84 Axis
86 Side wall
88, 90 Front wall
92 Edge
94 Bottom wall
96 Apex line
98 Edge
99 Wall portion
100 Drive device
102 Shaft
104 Axis of rotation
106 Control device
108 Direction of rotation
110 Mixing element
112 Conveying element
114 Sliding portion
116 First chamber region
118 Second chamber region
120 Recess
122 Sliding portion
124 Wiper portion
126 Direction of rotation
128 Axis
130 Side wall
132, 134 Front wall
136 Apex line
138 Bottom wall
140 Drive device
142 Shaft
144 Axis of rotation
146 Direction of rotation
148 Mixing element
150 Conveyor element
152 Holding portion
153, 155, 157 Segment
154 Sliding portion
156 Direction of rotation
158 Heating device
160 Ventilation device
162 Air guide part
164 Arrow
166 Pressure generation unit
168 Fan
170 Channel
172 Condensation device
174 Condenser
176 Condensate container
178 Heating device
180 Air guide part
182 Arrow
184 Humidifying device
186 Pump
188, 190 Sensor device
192 Control unit
194 Load cell

1. Composting apparatus for providing compost material from organic material, comprising
at least one initial chamber and at least one subsequent chamber,
wherein the at least one initial chamber and the at least one subsequent chamber comprise a composting chamber in which organic material is convertible to compost material,
wherein the at least one initial chamber comprises an introduction opening and a discharge opening and organic material is introducible into the at least one initial chamber through the introduction opening,
wherein the at least one subsequent chamber comprises an introduction opening,
a conveying unit on at least one initial chamber, having at least one conveying element for the organic material, said conveying element being arranged in said initial chamber; and
a control device for actuating the conveying unit, wherein the organic material is conveyable by means of the conveying unit through the discharge opening for transfer to the at least one subsequent chamber.

2. Composting apparatus in accordance with claim 1, wherein a drying chamber is provided as the initial chamber and the composting chamber as the subsequent chamber, the composting apparatus comprising a heating device which is arranged on the drying chamber and is actuatable by the control device, and by means of which heating device the organic material is heatable in the drying chamber for drying, and the dried organic material being able to be supplied via the conveying unit of the composting chamber for composting.

3. Composting apparatus in accordance with claim 2, wherein the composting apparatus comprises a respective conveying unit on the drying chamber and on the composting chamber, which conveying units are actuatable independently of one another by the control device.

4. Composting apparatus in accordance with claim 1, wherein the composting chamber is provided as the initial chamber and a removal container is provided as the subsequent chamber, organic material supplied in the composting chamber being convertible to compost material, and compost material being able to be supplied to the removal container via the conveying unit.

5. Composting apparatus in accordance with claim 1, wherein the composting apparatus comprises a sensor device coupled to the control device, and wherein the conveying unit is actuatable depending on a signal from the sensor device.

6. Composting apparatus in accordance with claim 5, wherein the conveying unit is actuatable in accordance with at least one of the following:
ensuring a predetermined residence time of the organic material in the initial chamber;
ensuring a state of the organic material before transfer into the subsequent chamber;
transferring a predetermined amount of organic material into the at least one subsequent chamber.

7. Composting apparatus in accordance with claim 1, wherein the conveying unit comprises a drive device and a shaft which is rotatable about an axis of rotation via the drive device and on which the at least one conveying element is fixed.

8. Composting apparatus in accordance with claim 7, wherein the axis of rotation is an axis of the at least one initial chamber.

9. Composting apparatus in accordance with claim 7, wherein the at least one conveying element comprises a holding portion and a sliding portion connected thereto, the holding portion being held on the shaft and the sliding portion pushing organic material in the direction of the discharge opening.

10. Composting apparatus in accordance with claim 9, wherein the sliding portion is a wiper portion which is movable along an inner wall of the at least one initial chamber.

11. Composting apparatus in accordance with claim 7, wherein the at least one initial chamber comprises a first chamber region and a second chamber region and the conveying element is disk-shaped and separates the first chamber region from the second chamber region, wherein the discharge opening is arranged on the second chamber region and, on the conveying element, at least one recess and at least one sliding portion are arranged, by means of which sliding portion organic material is conveyable through the recess from the first chamber region into the second chamber region.

12. Composting apparatus in accordance with claim 7, wherein the conveying unit is operable in two operating modes, said conveying unit being effective in a first operating mode as a conveying unit for transporting the organic material into the at least one subsequent chamber, and said conveying unit being effective in a second operating mode as a mixing unit for mixing the organic material in the at least one initial chamber.

13. Composting apparatus in accordance with claim 12, wherein the conveying unit is actuatable by the control device to carry out the respective operating mode.

14. Composting apparatus in accordance with claim 12, wherein at least one of the following applies:
in the second operating mode, organic material is movable, by means of at least one mixing element of the conveying unit, in a direction pointing away from the discharge opening;
at least one conveying element comprises or forms a mixing element, or vice versa.

15. Composting apparatus in accordance with claim 12, wherein the operating modes differ from one another by a direction of rotation of the conveying unit about the axis of rotation.

16. Composting apparatus in accordance with claim 1, wherein the initial chamber is arranged at least in portions above the subsequent chamber, and wherein organic material is transferrable from the at least one initial chamber into the at least one subsequent chamber under the influence of gravity.

17. Composting apparatus in accordance with claim 1, wherein the subsequent chamber projects beyond an outer contour of the initial chamber.

18. Composting apparatus in accordance with claim 1, wherein the composting apparatus is free of moving elements at the discharge opening, at at least one of the introduction opening and a channel extending therebetween.

19. Composting apparatus in accordance with claim 1, wherein the at least one initial chamber comprises a wall arrangement having a bottom wall on which the organic material rests.

20. Composting apparatus in accordance with claim 19, wherein the discharge opening is arranged above at least one of the bottom wall and an apex of the bottom wall.

21. Composting apparatus in accordance with claim 1, wherein the bottom wall is free of a discharge opening.

22. Composting apparatus in accordance with claim 1, wherein the at least one initial chamber is cylindrical or substantially cylindrical and defines an axis, the wall arrangement comprising a jacket-like side wall surrounding the axis, and opposite end walls.

23. Composting apparatus in accordance with claim 22, wherein the axis is oriented in parallel with a contact plane of the composting apparatus for contacting a positioning surface.

24. Composting apparatus in accordance with claim 22, wherein the discharge opening is formed in the side wall.

25. Composting apparatus in accordance with claim 24, wherein at least one of the following applies:
the discharge opening is arranged at least in portions above the axis and/or is designed as an overflow opening into which the organic material is raisable by means of the conveying element;
the discharge opening is slot-shaped;
the discharge opening extends in parallel with the axis.

26. Composting apparatus in accordance with claim 22, wherein the discharge opening is formed in an end wall.

27. Composting apparatus in accordance with claim 26, wherein at least one of the following applies:
a wall portion of the end wall is present between the discharge opening and the bottom wall and/or an apex of the bottom wall;
the discharge opening is arranged at least in portions below and/or at least in portions above the axis;
the discharge opening is arranged off-center relative to the axis;
the discharge opening is round;
the organic material is pressable through the discharge opening by means of the conveying element.

28. Composting apparatus in accordance with claim 1, wherein a channel is provided into which the initial chamber opens via the discharge opening and which opens into the subsequent chamber via the introduction opening.

29. Composting apparatus in accordance with claim 1, wherein the channel is in the form of a shaft and extends at least in portions in a vertical direction.

30. Composting apparatus in accordance with claim 1, wherein the composting apparatus comprises at least one heating device on at least one of the at least one initial chamber and the at least one subsequent chamber, by means of which a wall arrangement of at least one of the at least one initial chamber and the at least one subsequent chamber is heatable.

31. Composting apparatus in accordance with claim 1, wherein the composting apparatus comprises at least one ventilation device having at least one pressure generation unit and at least one air guide part by means of which air is guidable to or into at least one of the at least one initial chamber and the at least one subsequent chamber.

32. Composting apparatus in accordance with claim 31, wherein the at least one air guide part surrounds the wall arrangement of the at least one initial chamber and/or the wall arrangement surrounds the at least one subsequent chamber at least in portions, and wherein the air flows along between the air guide part and the wall arrangement, the air being heatable by means of the at least one heating device.
